(19) United States
(12) Patent Application Publication
(10) Pub. No.: US 2025/0216293 A1
(43) Pub. Date: Jul. 3, 2025

(54) Method for Determining the Wear Volume of a Sliding-Ring Seal in Singular Wear Events by Means of High-Temporal-Resolution Temperature Measurement

(71) Applicant: KSB SE & Co. KGaA, Frankenthal (DE)

(72) Inventor: Joachim OTSCHIK, Murnau (DE)

(21) Appl. No.: 18/848,972

(22) PCT Filed: Feb. 14, 2023
(86) PCT No.: PCT/EP2023/053604

§ 371 Date: Sep. 20, 2024

(30) Foreign Application Priority Data
Mar. 21, 2022 (DE) 10 2022 000 970.6

(51) Int. Cl. G01M 13/005; G01K 3/10; G01N 3/56

(52) U.S. Cl. CPC G01M 13/005; G01N 3/56; G01K 3/10; G01N 2203/0694

(57) ABSTRACT

A method for determining wear volume of a mechanical seal includes measuring a temperature at a seal face or seat of the mechanical seal with high temporal resolution. An area under a function of a measured temperature profile in a case of short-term temperature changes which are less than 60 s, compared with a normal temperature, which corresponds to a temperature profile of a mechanical seal without wear, is determined by measuring the temperature profile with subsequent integration of a function of the measured temperature profile. The area being multiplied by a mechanical seal-specific factor in order to calculate the wear volume.

### CROSS REFERENCE TO RELATED APPLICATION

This application claims priority under 35 U.S.C. § 119 from German Patent Application No. 10 2022 000 970.6, filed Mar. 21, 2022, the entire disclosure of which is herein expressly incorporated by reference.

### BACKGROUND

Slip ring seals (FIG. 1) are machine elements that are used for sealing of rotating conveyor devices. These conveyor devices include almost all pumps and compressors in global use. The purpose of a slip ring seal is to maximize leakproofing or minimize leaks with simultaneously low energy consumption. Central elements of these slip ring seals are the slip ring and the counterpart ring. The main sealing takes place between these two rings, between which a seal gap in the sub-micrometre range is established. The requirement to minimize emissions (leaks) minimizes the height of the seal gap. In operation, this leads to contact between slip ring and counterpart ring with varying frequency over time and hence to wear. There would be no wear without this contact between slip ring and counterpart ring.

### SUMMARY

The disclosure is concerned with a test method that determines wear and the rate of wear (wear per unit time). It is thus possible for the first time during operation of a slip ring seal to be able to determine the expected lifetime of the slip ring seal with practicable accuracy.

### BRIEF DESCRIPTION OF THE DRAWINGS

FIG. 1 depicts an arrangement of slip ring seal with leakage profile;

FIG. 2 depicts an arrangement of slip ring seal with temperature measurement;

FIG. 3 depicts an arrangement of buffered double seal;

FIG. 4 depicts a temperature progression; and

FIG. 5 depicts cold welding of two SiO₂ surfaces.

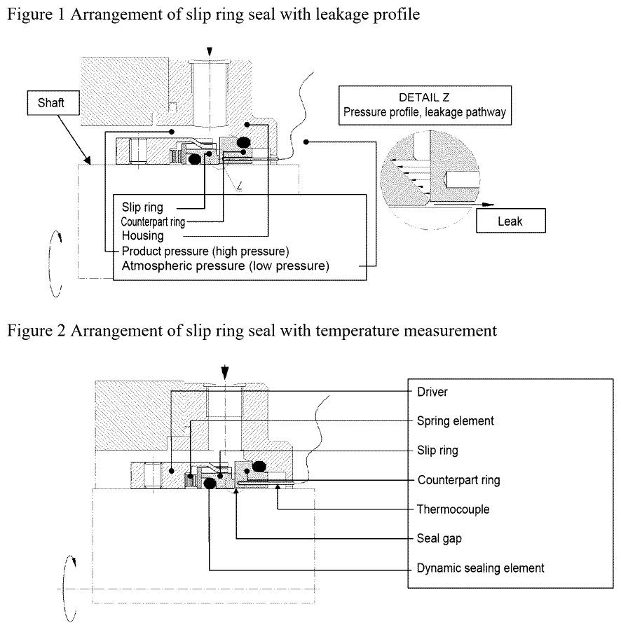

### DETAILED DESCRIPTION

For more than twenty years, there have been various approaches to measuring wear (wear volume, wear height) and wear rate in slip ring seals. A distinction is made fundamentally between test methods by means of direct parameters and indirect parameters. The direct test methods include:
wear height
tracers

The indirect test methods include:
oscillation (structure borne sound, vibration)
digital twin: combination of temperature, pressure, speed, fluid, geometry
torque
leakage
temperature

Wear height: Sensing of wear height is a practicable test method according to the current prior art in order to determine wear. For this purpose, a wear element is applied, for example, in the seal gap. If there is a change in height, i.e. the thickness of this wear element, there will be a change, for example, in the electrical resistance of the wear element.

Another design is the introduction of a contact into the body to be subjected to wear, which sends a signal when contact is achieved as a result of the wear. Several contacts at different wear heights are possible.

However, disadvantages of these solutions are the local restriction of measurement and sensitivity, especially in the case of rings made of very hard material such as silicon carbide. This is because, in the case of slip ring seals with silicon carbide rings, even a few micrometres (1-10 μm) of wear is sufficient to greatly impair their sealing function.

Tracers: Tracer-based wear measurements have high resolution. For this purpose, the slip rings and counterpart rings are doped with tracers that can then be measured outside the slip ring seal with the abraded material in the gas phase or in the liquid phase. However, the level of technical complexity associated with these measurements is very high. Therefore, this test method is generally used solely in the laboratory.

Oscillation: Measurement of active and passive oscillation is prior art in all frequency ranges of technical relevance and is used for the analysis of the state of pumps, and also of slip ring seals.

Two major technical drawbacks have been found. Measurements of oscillation have the problem of having to work in an environment augmented with extraneous sound signals. The filtering of sealing-relevant signals is very complex outside laboratory use, and in some cases not even possible.

The filtering of relevant signals can be improved with excited measurement systems. However, the response function, rather than describing wear characteristics, describes the coupling area and the size distribution (of the individual contact surfaces) in the μm² range between slip ring and counterpart ring.

Digital twin: A digital twin is the modelling of the behaviour of a component with regard to various target parameters. For the slip ring seal, the parameters of fluid temperature, speed, fluid pressure, other fluid properties including geometry and material properties of the seal are sufficient to calculate the seal gap established between slip ring and counterpart ring. It is always assumed in these models that there is a seal gap, no matter how small. The areas of slip ring and counterpart ring do not touch one another in these models. Therefore, they cannot be used for calculation of wear, based on contact, of slip ring seals.

Non-steady-state modelling of wear on an atomic basis is possible in principle, but fails because of the necessary size of contact owing to the limited computation power of current large-scale computers.

Torque: Mechanically decoupled measurement of torque between slip ring and counterpart ring is possible but technically very complex and often technically impracticable owing to lack of installation space.

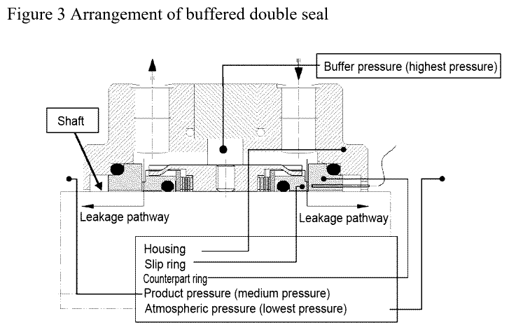

Leakage: In the case of buffered seal systems with two slip ring seals (FIG. 3), the measurement of leakage and the change therein over time is a good indicator to be able to make a statement as to the sealing function of the two slip ring seals.

In the case of single-action slip ring seals, leakage can be measured only on the side remote from the pressure, i.e. toward the atmosphere. However, this is technically possible only when the seal has relatively high leakage as standard. These seals have a seal gap that ensures the corresponding normal, slightly higher leakage. Wear does not take place owing to lack of contact of slip ring and counterpart ring, unless the seals make contact in startup and shutdown processes.

By contrast, contact sealing often shows leakage that is practically immeasurable because the greatest part of the leakage (particularly in the case of water applications) evaporates. Critical wear states additionally also occur when the leakage or seal gap tends to zero. These are undetectable by leakage measurements in the case of contact seals.

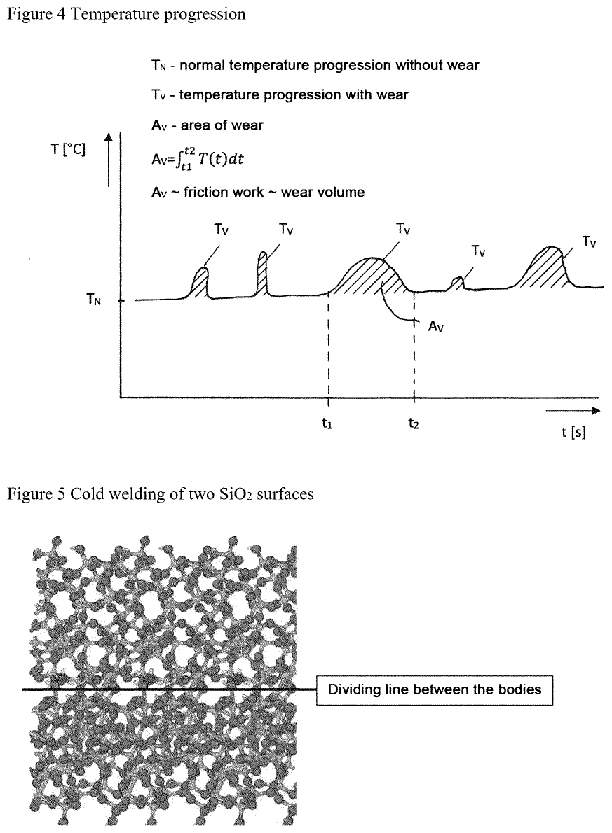

Temperature: The measurement of temperature of slip rings and counterpart rings in slip ring seals is prior art. What is evaluated is the normal temperature T_{N} (FIG. 4).

However, this temperature does not say anything about the wear, the state of wear and the wear rate of slip ring and counterpart ring. It is determined (is established) via the temperature of the sealing medium, the media properties, the seal design and the speed. It is part of the “digital twin” test method already described.

The following prior art publications were cited:
/1/ DE 10 2007 026 743 A1
/2/ DE 10 2018 125 969 A1
/3/ DE 197 24 308 A1
/4/ EP 3 139 072 A1
/5/ EP 3 502 525 A1

The present disclosure was made against the background of the above prior art, and the problem addressed by the present disclosure was that of providing a practical method by which it is possible to measure and accumulate the wear of slip rings and counterpart rings in slip ring seals, and hence to predict technical failure with high quality with regard to the expected probability of occurrence over time.

The object was achieved by a test method that measures the indirect parameter of temperature on the slip ring or the counterpart ring with high time resolution. It has been found that, unexpectedly, in the case of highly time-resolved temperature measurement of slip ring and counterpart ring in a slip ring seal, typical temperature progressions occur (FIG. 4), which enable direct conclusion of wear characteristics. The typical measurement time for such an event is generally in the range from a few milliseconds to 60 s; the change in temperature (T_{V}=f(t)) compared to the “normal temperature” (T_{N}) is less than 10 K.

In the case of macroscopic “contact” between two moving surfaces, here the contact surfaces of slip ring and counterpart ring, it is typically possible to describe three tribological states on a small length scale: atomic contact with bonding of the surfaces at the molecular level (called cold welding (FIG. 5)), atomic contact with inert surfaces (small shear forces), and surfaces between which a thin liquid film is being sheared. All three tribological states lead overall to a total shear force, or to a friction value when the shear force is based on the normal force. It has been found that there is a non-steady-state proportion of cold-welded contacts. However, the effect of the cold-welded contacts is in any case that, depending on the material pairing of slip ring and counterpart ring and external boundary conditions, there is abrupt breakout of very small material constituents from the contact surface. This process (breakout) consumes energy since the surface area becomes greater on breakout (surface energy). However, there is a brief rise in temperature thereafter on a very small timescale (FIG. 4, T_{V}). This is because of the broken-out material constituents that then break up in the seal gap and are discharged. The greater the volume of particle breakout, the longer these particles remain in the seal gap, and the longer the brief temperature rise measured. This discharge process is seal-dependent (geometry, materials, pressure, temperature, speed, fluid . . . ) and thus has surprisingly good reproducibility. This means that the area (A_{V}) beneath the function T=f(t), in a seal-specific manner, is directly proportional to friction work and to the wear volume sought. This method can be used in accordance with the disclosure in a very simple manner in order to measure or to calculate total wear over a large timescale. All that is required is a temperature measurement device, for example a thermocouple in the slip ring or counterpart ring, ideally in the stationary ring of the slip ring seal. The temperature-time curve measured, as described, depends on the heat source (friction by wear particles) and the heat transfer and storage boundary conditions of the slip ring seal. If the heat transfer boundary conditions are known, it is additionally possible to extend the test method for measurement of wear such that individual instances of wear can be subjected to deeper tribological examination (dry running, wear by external particles, wear by broken-out particles, size of particles).

It is often difficult in practice to test every seal design used in its real environment in the laboratory. But here too, the test method described in accordance with the disclosure enables a practicable solution. Assuming that slip ring seals will always seal similarly under constant boundary conditions, it is possible to predict the time of failure. For this purpose, what is called a first sacrificial seal is used for calibration of the maximum possible wear before failure, with the aid of the test method described. The subsequently installed seals that follow use the results of the sacrificial seal.

The foregoing disclosure has been set forth merely to illustrate the disclosure and is not intended to be limiting. Since modifications of the disclosed embodiments incorporating the spirit and substance of the disclosure may occur to persons skilled in the art, the disclosure should be construed to include everything within the scope of the appended claims and equivalents thereof.

1.-10. (canceled)

11. A method for determining wear volume of a mechanical seal in case of singular wear events, the method comprising:
measuring a temperature (Tᵥ) at a seal face or seat of the mechanical seal with high temporal resolution, wherein
an area (Aᵥ) under a function of a measured temperature profile (Tᵥ=f(t)) in a case of short-term temperature changes (dt) which are less than 60 s, compared with a normal temperature (T_{N}), which corresponds to a temperature profile of a mechanical seal without wear, is determined by measuring the temperature profile (Tᵥ) with subsequent integration of a function of the measured temperature profile (Tᵥ=f(t)), the area (A_{V}) being multiplied by a mechanical seal-specific factor in order to calculate the wear volume.

12. The method as claimed in claim 11, further comprising: determining a total wear at a time t and a wear rate.

13. The method as claimed in claim 12, wherein the total wear is set in relation to a maximum possible wear in order to predict a time of a mechanical seal failure.

14. The method as claimed in claim 13, wherein a probability of occurrence of the mechanical seal failure is improved with each new failure event by taking into account historical failure events.

15. The method as claimed in claim 14, wherein the determining of the wear volume of the mechanical seal is divided into two sub-processes:
a first sub-process of determining the area (Aᵥ) in a decentralized evaluation unit, in a region of the mechanical seal; and
a second sub-process of forwarding the determined area (Aᵥ) to a central evaluation unit, which links a mechanical seal-specific factor with the calculated area (Aᵥ) using a mechanical seal-specification in order to calculate the wear volume.

16. The method as claimed in claim 15, wherein the mechanical seal-specific factor is determined in advance by laboratory measurements.

17. The method as claimed in claim 16, wherein the mechanical seal-specific factor is calculated based on a single measurement of an installed mechanical seal over an entire service life, which begins at initial operation until the mechanical seal fails.

18. The method as claimed in claim 17, further comprising: forming wear classes dependent on an operating condition, which give an operator of the mechanical seal the possibility of specifically minimizing wear by avoiding wear classes with high wear.

19. The method as claimed in claim 18, wherein singular wear events are assigned to specific causes, including dry running or entry of external particles into a sealing gap from a suspension that is sealed.

20. The method as claimed in claim 12, further comprising: assuming an average area (Aᵥ) for all singular wear events, so that only a number of singular wear events is multiplied by a mechanical seal-specific factor to determine total wear.
